(19) United States
(12) Patent Application Publication
(10) Pub. No.: US 2005/0116815 A1
(43) Pub. Date: Jun. 2, 2005

(54) Light source control module

(76) Inventors: Tony K. T. Chen, Tao Yuan (TW); Ching-Horng Hsiao, TaiChung (TW); Yu-Hsi Yang, Taipei (TW); James Lee, I-Lan (TW)

Correspondence Address: Raymond Sun, 12420 Woodhall Way, Tustin, CA, 92782, US

(21) Appl. No.: 10/918,106

(22) Filed: Aug. 13, 2004

(30) Foreign Application Priority Data
Nov. 28, 2003 (TW) 92221046

(51) Int. Cl. G08B 5/00

(52) U.S. Cl. 340/331; 340/815.4

(57) ABSTRACT

A lighting assembly has a light source main body and a light source control module. The light source main body has a light source that generates light. The light source control module includes a power switch, a housing removably coupled to the light source main body, and a modulation circuit retained inside the housing. The modulation circuit is electrically connected to the power switch for making the light source flash with a frequency when the power switch is turned on.

### BACKGROUND OF THE INVENTION

1. Field of the Invention

The present invention relates to a light source control module, and in particular, to a light source control module having a modulation switch for controlling the light source to emit beams with different modulated frequencies.

2. Description of the Prior Art

In a conventional light source device, such as a conventional flashlight, LED flashlight or a laser generator, a conventional switch having simple on/off function is used. Since only the simple on/off function is provided, the light source has a limited purpose. As one example, conventional flashlights are turned on and off by a switch so that the flashlight is provided only for emitting light. However, in certain special conditions, it may be desirable to use the flashlight for flashing purposes, such as to provide a continuous flash for getting attention or as a messaging means. In such conditions, the flashlight must be continuously switched on and off, which will shorten the service life of the switch. As another example, laser sights are commonly used at rifle and golf clubs, with a flashlight-type or pen-type laser generator continuously emitting a laser beam with a specific spectrum.

A conventional laser generator is shown in FIG. 1A. A back cover device 20 is engaged with the tail of a laser main body 10a in which a laser generator 101a and a battery 102a (providing power for the laser generator 101a) are disposed. The back cover device 20 has a cover body 21 and a screw thread 211 capable of engaging a screw thread 11a defined on the laser main body 10a. Thus, the cover body 21 is removably engaged to the tail of the laser main body 10a. The cover body 21 has a power switch 25 or a power cable 241 connected to an external power switch 24 (see FIG. 1B). One end of the power switch 24 or 25 is electrically connected to a contact 232 on a circuit board 23 of the back cover device 20. The contact 232 is electrically connected to a battery 102a positioned in the laser main body 10a. The power switch 24 or 25 is used to turn the power on and off.

As described above, the power switches 24, 25 are simple mechanical switches providing simple on and off functions. Such functions cannot satisfy a user's demand in certain particular conditions. For example, for a laser sight used in a gun, when people shoot in a shooting field, a user can hardly recognize the laser spot of his gun from so many different laser spots. To resolve such a problem, it is desirable to use a light source control module that can vary the flash frequency of the laser spot to distinguish it from other lasers.

### SUMMARY OF THE DISCLOSURE

It is an object of the present invention to provide a light source control module capable of being engaged with a light source main body for making the light source flash with different frequencies.

It is another object of the present invention to provide a light source control module capable of replacing the conventional back cover device and compactly engaging with the light source main body for achieving portable use, and reducing volume and cost.

It is yet another object of the present invention to provide a light source control module that is capable of pre-setting and saving the modulation mode in order to control the light source main body to emit a particular flash light for communication purposes.

In order to accomplish the objects of the present invention, the present invention provides a lighting assembly having a light source main body and a light source control module. The light source main body has a light source that generates light. The light source control module includes a power switch, a housing removably coupled to the light source main body, and a modulation circuit retained inside the housing. The modulation circuit is electrically connected to the power switch for making the light source flash with a frequency when the power switch is turned on. The modulation circuit can have a plurality of modulation modes modulated by an analog method or a digital method. As a result, the light emitted from the light source can have different frequencies.

### BRIEF DESCRIPTION OF THE DRAWINGS

FIGS. 1A and 1B are exploded perspective views of two conventional laser sights.

FIG. 2 is an exploded perspective view of a light source control module in accordance with one embodiment of the present invention.

FIG. 3 is a cross-sectional view of the light source control module of FIG. 2.

FIG. 4 is a perspective view showing the light source control module of FIG. 2 engaging the light source main body.

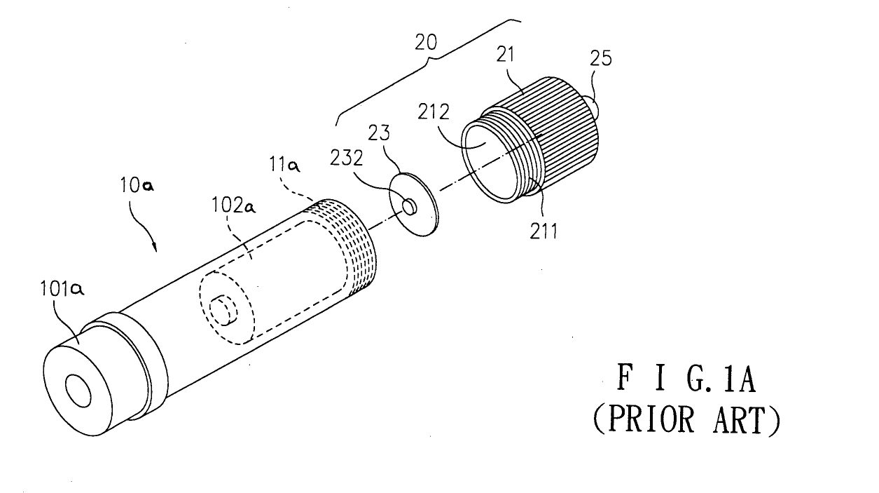

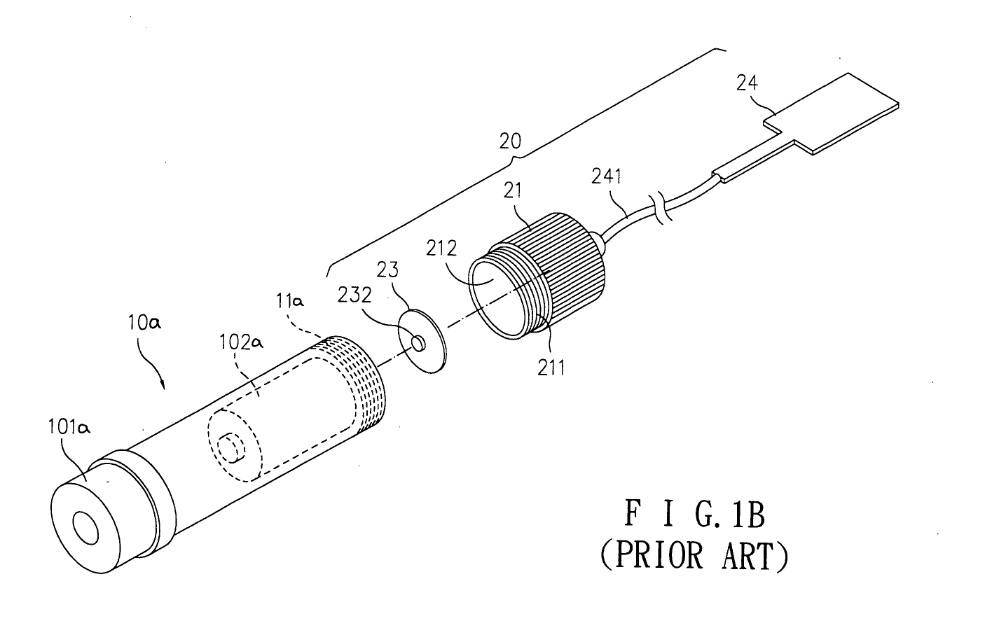

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

The light source control module 30 of the present invention can be used for various types of light sources. A laser main body 10 is described as a light source. The light control module 30 of the present invention can be used with the laser main body 10 as a power switch. A laser generator 101 and a battery 102 (providing power for the laser generator 101) are disposed in the laser main body 10. The laser generator 101 can be a conventional laser generator.

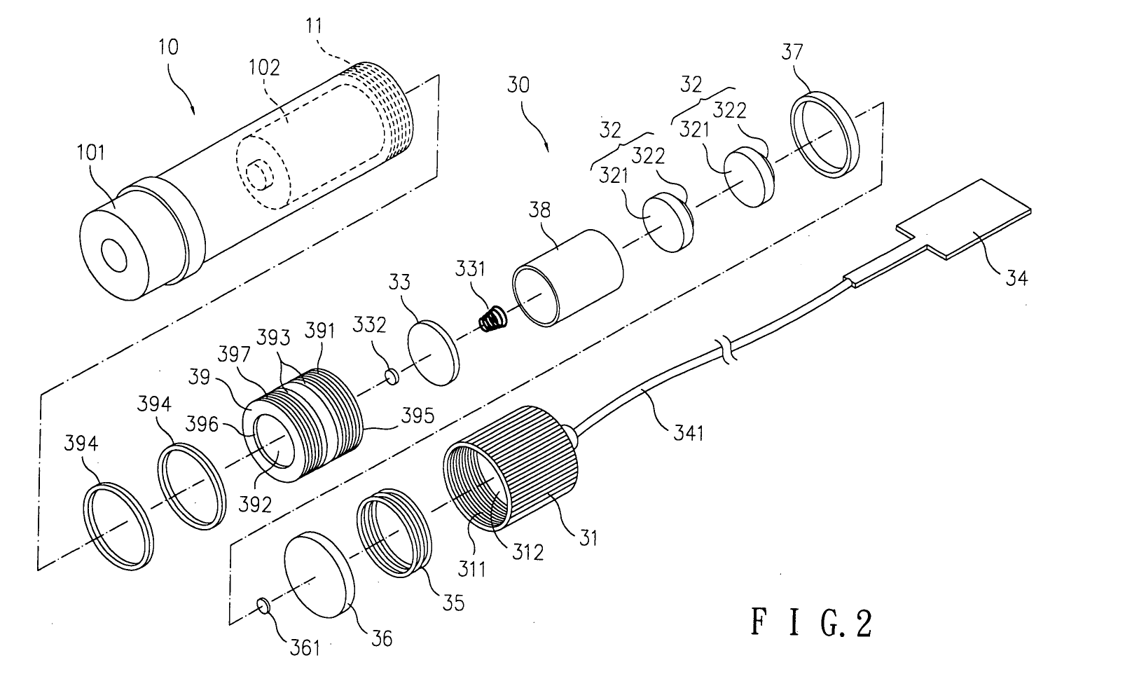

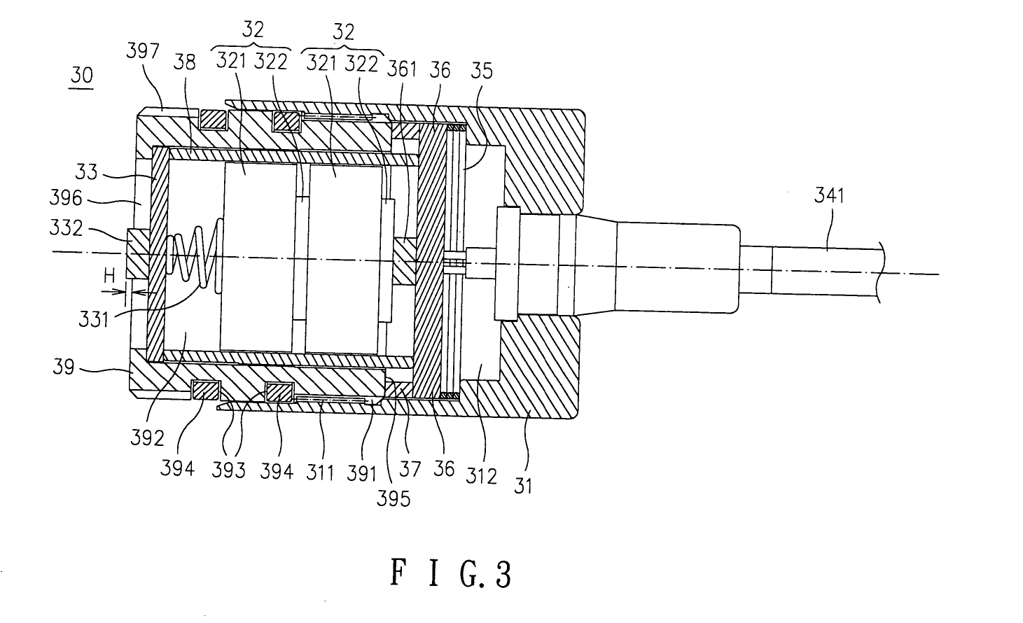

Referring to FIGS. 2 and 3, the light source control module 30 has a housing that includes a cover 31 and a connection sleeve 39. Receiving spaces 312 and 392 are defined inside the cover 31 and the connection sleeve 39, respectively. A power cable 341 is connected to the cover 31 and a power switch 34. Screw threads 311 and 391 are defined on the inner wall of the cover 31 and the outer wall of the connection sleeve 39, respectively. A plurality of grooves 393 are defined on the outer wall of the connection sleeve 39 for receiving one or more rings 394. External screw threads 397 are defined on the other end of the connection sleeve 39 for engaging corresponding internal screw threads 11 in the laser main body 10.

A modulation circuit board 36 is disposed in the cover 31. The power switch 34 is electrically connected to the modulation circuit board 36 for turning the laser main body 10 on and off to-emit modulated laser beam. The modulation circuit board 36 contains a modulation circuit (which can be conventional circuitry) that is designed to control the laser generator 101 to emit different modulated beams. The modulation circuit can also be provided on the circuit board 33 described below. The modulation circuit has multi-frequency adjusting function for modulating the laser beam to have various flashing frequencies. The modulation circuit board 36 is driven by the battery 102 disposed in the laser main body 10. In addition, an independent power supply device may be used to provide power for the modulation circuit board 36. The modulation method of the modulation circuit 36 can either be analog modulation or digital modulation, which are well known in the art.

The connection sleeve 39, a conducting spring 35, the modulation circuit board 36, and a pressing ring 37 are disposed inside the receiving space 312. A contact 361, a plurality of batteries 32, a battery tube 38, a conducting spring 331, a circuit board 33 and a contact 332 are disposed inside the receiving space 392 of the connection sleeve 39. The conducting spring 35 is disposed at the proximal-most end of the receiving space 312, with the modulation circuit board 36 pressed against the conducting spring 35, and the pressing ring 37 pressed against the modulation circuit board 36. The power cable 341 passes through the cover 31 and is electrically connected to the contact 361 on the modulation circuit board 36.

The circuit board 33 is positioned at the distal-most end of the receiving space 392, with the conducting spring 331 disposed on one side of the circuit board 33 facing the cover 31, and the contact 332 disposed on the other side of the circuit board 33. An opening 396 is defined on the distal end of the connection sleeve 39. The contact 332 may extend through the opening 396 by a predetermined distance H measured from the distal end of the connection sleeve 39.

One or more batteries 32 are placed in the receiving space 392. The positive end 321 of the distal-most battery 32 contacts the conducting spring 331 and the negative end 322 of the proximal-most battery 32 contacts the contact 361 disposed on the modulation circuit board 36. The connection sleeve 39 is received from the distal end of the cover 31 into the receiving space 312. The ring(s) 394 can be used to seal the screwed cover 31 and connection sleeve 39. The pressing ring 37 is pressed by the edge 395 of the connection sleeve 39 to ensure that the modulation circuit board 36 contacts the conducting spring 35 for electrical conduction therebetween. The batteries 32 are pressed by the conducting spring 331 to ensure that the batteries 32 constantly engage the contact 361.

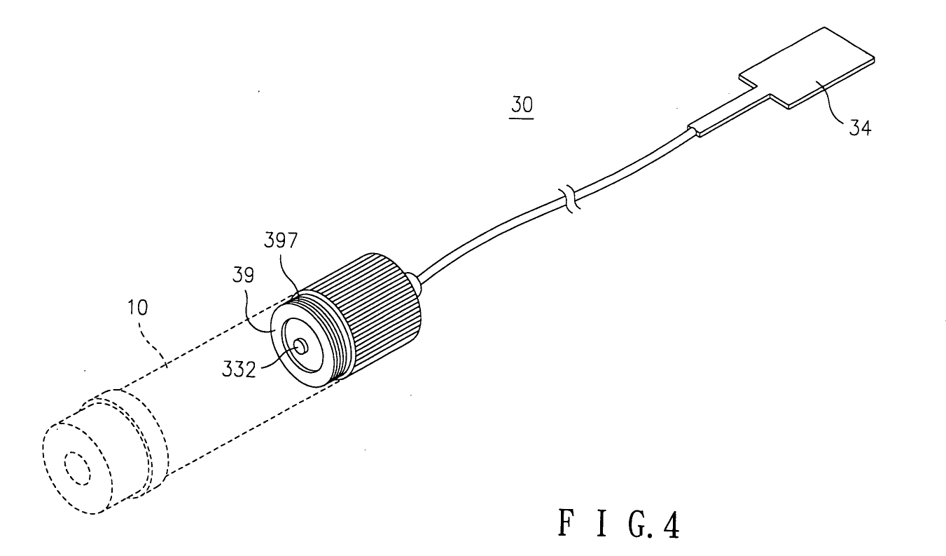

As best shown in FIGS. 3 and 4, the light source control module 30 can be engaged with the tail of the laser main body 10 via the screw thread 397. The exposed contact 332 can contact the corresponding contact disposed on the tail of the laser main body 10 for electrical conduction between the light source control module 30 and the laser main body 10. The laser main body 10 is then turned on and off by the power switch 34. When the power switch 34 is turned on, the laser generator 101 emits a flashing laser beam.

The power switch 34 can be either externally disposed and connected to the cover 31 via the power cable 341, or can be directly disposed on the cover 31.

Although the present invention is applicable to a laser main body as described herein, the principles of the present invention can also be applicable to other light sources such as a flashlight. The modulation circuit of the present invention can control the flashlight to emit various flashes. In addition, various modulation modes such as Morse codes may be stored into the modulation circuit in advance so that the flashlight can be used as a communication instrument.

As described above, the modulation switch of the present invention replaces the conventional on/off switch so that the light source can be used not only for lighting purposes, but also for communication, warning and signal transmission purposes. The modulation circuit is removably secured in a housing to simplify the structure, and allow it to be compatible with conventional light sources.

While the description above refers to particular embodiments of the present invention, it will be understood that many modifications may be made without departing from the spirit thereof. The accompanying claims are intended to cover such modifications as would fall within the true scope and spirit of the present invention.

1. A lighting assembly, comprising:
a light source main body having a light source;
a light source control module comprising:
a power switch;
a housing removably coupled to the light source main body; and
a modulation circuit retained inside the housing, the modulation circuit electrically connected to the power switch for making the light source flash with a frequency when the power switch is turned on.

2. The assembly of claim 1, wherein the frequency is adjustable.

3. The assembly of claim 1, wherein a plurality of screw threads is defined on the housing and the light source main body for removably engaging the housing to the light source main body.

4. The assembly of claim 1, wherein the housing comprises a cover and a connection sleeve, with both the cover and the connection sleeve having screw threads thereon for screwing the cover to the connection sleeve.

5. The assembly of claim 1, further comprising a power supply provided in the housing for providing power to the modulation circuit.

6. The assembly of claim 5, wherein the power supply comprises a battery sleeve, a battery, a circuit board and a conducting spring, with the battery and the conducting spring arranged inside the battery sleeve.

7. The assembly of claim 6, wherein the modulation circuit has a contact point electrically connected to the battery, and the modulation circuit is electrically connected to the housing via the conducting spring; and
wherein the power supply has a contact point electrically contacting the light source, and the power supply is electrically connected to the modulation circuit via the battery sleeve.

8. The assembly of claim 4, wherein a ring is disposed at a location where the cover engages with the connection sleeve.

9. The assembly of claim 4, wherein a pressing ring is disposed between the connection sleeve and the modulation circuit.

10. The assembly of claim 1, wherein the light source is a laser generator.

11. A light source control module, comprising:
a power switch;
a housing; and
a modulation circuit retained inside the housing, the modulation circuit electrically connected to the power switch for making a separate light source flash with a frequency when the power switch is turned on.

12. The module of claim 11, wherein the frequency is adjustable.

13. The module of claim 11, wherein a plurality of screw threads is defined on the housing for removably engaging a housing of a separate light source.

14. The module of claim 11, wherein the housing comprises a cover and a connection sleeve, with both the cover and the connection sleeve having screw threads thereon for screwing the cover to the connection sleeve.

15. The module of claim 11, further comprising a power supply provided in the housing for providing power to the modulation circuit.

16. The module of claim 15, wherein the power supply comprises a battery sleeve, a battery, a circuit board and a conducting spring, with the battery and the conducting spring arranged inside the battery sleeve.

17. The module of claim 16, wherein the modulation circuit has a contact point electrically connected to the battery, and the modulation circuit is electrically connected to the housing via the conducting spring; and
wherein the power supply has a contact point, and the power supply is electrically connected to the modulation circuit via the battery sleeve.

18. The module of claim 14, wherein a ring is disposed at a location where the cover engages with the connection sleeve.

19. The module of claim 14, wherein a pressing ring is disposed between the connection sleeve and the modulation circuit.

20. The module of claim 11, wherein the power switch is disposed on the housing.
